(19) United States
(12) Patent Application Publication
(10) Pub. No.: US 2013/0175985 A1
(43) Pub. Date: Jul. 11, 2013

(54) RAPID CHARGE, ON-THE-GO TRANSPORTATION SYSTEM

(71) Applicants: Thomas Percich, St. Paul, MN (US); Karen Percich, St. Paul, MN (US)

(72) Inventors: Thomas Percich, St. Paul, MN (US); Karen Percich, St. Paul, MN (US)

(21) Appl. No.: 13/738,455

(22) Filed: Jan. 10, 2013

Related U.S. Application Data
(60) Provisional application No. 61/584,995, filed on Jan. 10, 2012.

(51) Int. Cl. H02J 7/00

(52) U.S. Cl. CPC H02J 7/00
USPC 320/108

(57) ABSTRACT

A rapid charge, on-the-go transportation system that (a) a plurality of roadways; and (b) a plurality of fast-charging, electrical energy sources placed along the roadways that are configured to charge plug-in, hybrid diesel, heavy duty trucks as they travel along the roadways.

### CROSS-REFERENCE TO RELATED APPLICATIONS

This application claims the benefit of U.S. Provisional Application Ser. No. 61/584,995, filed Jan. 10, 2012. The disclosure of the prior application is considered part of (and is incorporated by reference in) the disclosure of this application.

### TECHNICAL FIELD

This invention relates to transportation systems that use electrical energy.

### BACKGROUND

Electric and hybrid electric automobiles have been proposed as “green” alternatives to fossil fuel-powered automobiles. These automobiles often are powered by a rechargeable lithium-ion or nickel metal hydride battery incorporated in the vehicle. It would be desirable to extend this technology to heavy duty trucks that currently run on diesel fuel. One problem, however, is that the increased weight of the truck means that the truck's range between charging stops is limited. Consequently, use of electric and hybrid electric trucks has been limited to urban areas where the trucks are not required to travel long distances. In contrast, it is not cost-effective for long distance truckers to make frequent re-charging stops because the need for multiple stops slows down delivery. As a result, heavy duty trucks continue to rely exclusively upon diesel fuel as their energy source.

### SUMMARY

A rapid charge, on-the-go transportation system is described that includes a plurality of roadways; and (b) a plurality of fast-charging, electrical energy sources placed along the roadways that are configured to charge plug-in, hybrid diesel, heavy duty trucks as they travel along the roadways. In some embodiments, the trucks may include an on-board computer that calculates the most cost-effective route along the roadways based upon the cost of the energy source at a given time. The fast-charging, electrical energy sources may be further configured to charge plug-in, hybrid automobiles as well.

The fast-charging, electrical energy source may be a DC (level 3) fast-charging energy source. The fast-charging, electrical energy sources are placed above-ground or within the roadways. In some embodiments, the fast-charging, electrical energy sources may be placed at low miles-per-gallon locations such as uphill locations, urban locations, and combinations thereof. Electrical energy sources may also be placed in high air or noise pollution areas.

The transportation system described herein may offer a number of advantages. For example, it may lower trucking companies' overall costs of operating their fleets by providing a second energy option, and allowing the companies to use the lowest cost energy source (diesel vs. electric) at any given time, particularly when the trucks are “smart trucks” equipped with a computer that calculates the energy cost in real time for a given time and/or location. Ultimately, it may reduce overall diesel fuel consumption and reduce air pollution by decreasing emissions. Utilizing DC (level 3) fast-charging energy sources at the lowest miles per gallon areas also may reduce fleet operation cost. In addition, the system may increase utilization at power plants by providing a source for excess power, particularly excess electric power generated or power capacity at night. The system may also reduce traffic congestion during peak hours by encouraging trucks to operate at night when electric energy is cheapest.

The system may reduce air emissions and noise pollution. It may keep trucks on the road without the need to stop for fuel, thus creating delivery time savings. The system also may allow companies to choose the option of obtaining electricity from “green” or renewable energy sources. Companies may also choose to pre-purchase electricity at a set rate versus spot pricing, thereby allowing companies to hedge the rate into the future. Companies who hire truck delivery services also will have the option of choosing “green” companies for their delivery options. The system may also help those states and counties who are unable to expand manufacturing or other construction due to air quality limitations.

The details of one or more embodiments of the invention are set forth in the description below. Other features, objects, and advantages of the invention will be apparent from the description and from the claims.

### DETAILED DESCRIPTION

### A. Description of Charging Area

The charging stations can receive AC electrical power from an electrical grid. The AC power can be converted to DC power using a rectifier installed at each charging station. The grid electricity, in turn, can be provided by multiple sources, including renewable sources (e.g., wind, hydroelectric, and solar sources), nuclear sources, and fossil fuels (e.g., coal, oil, and natural gas). The charging station can also include solar panels or wind turbines to generate electricity locally.

Multiple charging stations can be positioned along freeways. They can be strategically located at low miles per gallon locations. Preferably, the stations could be located approximately every 50 miles to allow heavy duty trucks to supplement diesel fuel usage with electricity from batteries using a hybrid electric motor.

The stations can be above-ground or in-ground. The above-ground station can include continuous wires to supply electrical energy to the truck. The wire can be supported by or hung from poles on the side of the freeway with cantilevered arms extending over one or more lanes of traffic. The overhead wires could service one lane at a time. Certain areas could be equipped with multiple lanes of wires to handle the volume of truck traffic. The wire can connect to a heavy duty truck via a boom or harness that extends from the truck to the wire.

The in-ground station can include wires that are buried below ground and do not connect directly to the heavy duty truck. The electrical power would be transmitted wirelessly to a receiver connected to the truck. The receiver could be raised and lowered underneath the truck so that it rolls along the pavement.

Above-ground systems initially are less costly, while below-ground systems are more esthetically pleasing. Both, however, allow trucks to re-charge while in motion, thereby eliminating the need to stop and re-fuel. Consequently, the trucks have fewer emissions and are more cost-effective to operate.

Each charging station preferably includes a DC (level 3) fast charging system, and includes a charger that supports the DC (level 3) fast charging system (440 volts/100 amps or higher). The charging system preferably can allow for propulsion and battery charging simultaneously. The charging stations can include a charging area having a length sufficient to permit 80% charging of the truck battery before the truck leaves the charging area.

Regardless of whether the charging station is above-ground or in-ground, it preferably includes a wireless communications system that communicates with the heavy duty truck as the truck approaches the charging area. The truck driver can use the communications system to indicate if he wants to connect to the charging system. The driver can select a source of electric power from renewable or traditional sources, and, in response, receives a specific rate for the electric power. If the driver elects to re-charge, the charging system connects to the truck via overhead wires, in the case of an above-ground charging station, or wirelessly, in the case of an in-ground charging station. The system can then perform a safety check to see if the truck is ready for charging. If the truck is ready for charging, energy flow can begin.

During charging, the communications system can capture all relevant billing information, including truck and driver identification information, electrical usage, electrical energy source (renewable or traditional), and the electrical rate at the charging time based upon the electrical source selected. At the conclusion of the charging process, the communications system can send an electronic receipt to the driver or the truck owner once the truck disconnects from the charging area.

B. Description of “Smart Semi” Heavy Duty Truck

The individual heavy duty truck can be a “smart semi” truck that is operable in electric and diesel mode. For the former, the truck can include a battery (e.g., a lithium ion or nickel metal hydride battery) for propulsion. The truck can also include a boom or harness that can connect to the overhead wires of the charging stations. The truck can also include wireless communications equipment to allow the truck to communicate wirelessly in the case of in-ground charging stations. In addition, the truck can include an on-board computer that determines the most cost-effective route for the truck based upon energy costs (electric vs. diesel), time of day, distance, etc. The computer can provide the truck driver with real time determinations of electric power pricing, distance to next charging zone, battery utilization, air quality, noise and air pollution levels, topology, vehicle load, traffic congestion, construction delays, delivery constraints (e.g., time and dock availability), and the like. The net result would be cleaner, more cost-effective transportation.

A number of embodiments of the invention have been described. Nevertheless, it will be understood that various modifications may be made without departing from the spirit and scope of the invention. Accordingly, other embodiments are within the scope of the following claims.

What is claimed is:

1. A rapid charge, on-the-go transportation system comprising:
(a) a plurality of roadways; and
(b) a plurality of fast-charging, electrical energy sources placed along the roadways that are configured to charge plug-in, hybrid diesel, heavy duty trucks as they travel along the roadways.

2. The transportation system of claim 1, wherein the fast-charging, electrical energy sources are placed above-ground.

3. The transportation system of claim 1, wherein the fast-charging, electrical energy sources are placed within the roadways.

4. The transportation system of claim 1, wherein the fast-charging, electrical energy sources are placed at low miles-per-gallon locations.

5. The transportation system of claim 4, wherein the low miles-per-gallon positions are selected from the group consisting of uphill locations, urban locations, and combination thereof.

6. The transportation system of claim 1, wherein the fast-charging, electrical energy sources are placed at high noise and air pollution areas, low air quality locations, or a combination thereof.

7. The transportation system of claim 1, wherein the fast-charging, electrical energy sources comprise DC (level 3) fast-charging sources.

8. The transportation system of claim 1, wherein the trucks comprise an on-board computer that calculates the most cost-effective route along the roadways based upon the cost of the energy source at a given time.

9. The transportation system of claim 1, wherein the fast-charging, electrical energy sources are further configured to charge plug-in, hybrid automobiles.
